(19) United States
(12) Patent Application Publication
(10) Pub. No.: US 2011/0242039 A1
(43) Pub. Date: Oct. 6, 2011

(54) DISPLAY MODULE FOR A TOUCHSCREEN DISPLAY

(75) Inventors: Robert M. Kalis, Overland Park, KS (US); Christopher J. Hanshew, Lenexa, AZ (US)

(73) Assignee: GARMIN LTD., Camana Bay (KY)

(21) Appl. No.: 12/749,765

(22) Filed: Mar. 30, 2010

(51) Int. Cl. G06F 3/044; G09F 13/08; G09G 5/10; G06F 3/041; G06F 3/01; G06F 3/048

(52) U.S. Cl. 345/174; 362/97.1; 345/690; 345/173; 715/702; 715/835

(57) ABSTRACT

A display module for use in a touchscreen display of an electronic device. The display module includes a display screen, support structure for the display screen, and LEDs or other light sources for backlighting one or more touch-sensitive fixed icons on a touch panel positioned over the display module. The light sources are sandwiched between an inactive border area of the display screen and the support structure.

### BACKGROUND

Touchscreen displays are becoming increasingly popular in electronic devices because they allow operators to interact directly with what is displayed by the electronic devices, rather than indirectly with a keyboard, mouse, roller ball, or stylus. To simplify their use, many touchscreen displays have touch-sensitive fixed icons or “virtual” keys for certain popular functions or commands such as “Home,” “Menu,” “Back,” “Send,” and “End.”

### SUMMARY

Most touch-sensitive fixed icons are backlit for better visibility. Unfortunately, the light sources that provide such backlighting either take up space on the main circuit boards of their electronic devices or are sandwiched between the display modules and touch panels of the electronic devices and therefore increase the length and/or thickness of the electronic devices.

Embodiments of the present technology solve this problem by providing an improved display module for use in a touchscreen display of an electronic device. The display module includes a display screen, support structure for the display screen, and one or more LEDs or other light sources for backlighting one or more touch-sensitive fixed icons on a touch panel positioned over the display screen. The light sources are positioned or otherwise integrated between the display screen and the support structure for the display screen and are therefore integrated into the display module. In one embodiment, the light sources are mounted to a flexible printed circuit (FPC) that is positioned over a portion of an inactive border area of the display screen and sandwiched between the display screen and the support structure. Because the light sources are integrated into the display module rather than being positioned on top of the display module or mounted to the circuit board to which the display module is connected, the light sources take up otherwise unused space on the display module, thus reducing the overall size and/or thickness of the electronic device and/or permitting use of a larger display screen without increasing the overall size of the electronic device. Such a configuration also permits the touch-sensitive fixed icons on the touch panel to overlap a portion of the display module and still be backlit.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology are described in detail below with reference to the attached drawing figures, wherein:

FIG. 1 is a top view of an exemplary electronic device in which embodiments of the present technology may be used;

FIG. 2 is an exploded perspective view of portions of the electronic device of FIG. 1 illustrating its display module, touch panel, and other components in more detail; and

FIG. 3 is a top perspective view of the display module of the electronic device shown removed from the electronic device's main circuit board;

FIG. 4 is a rear perspective view of the display module of FIG. 3;

FIG. 5 is an exploded top perspective view of the display module;

FIG. 6 is an exploded rear perspective view of the display module;

FIG. 7 is a top perspective view of portions of the display module;

FIG. 8 is a bottom perspective view of portions of the display module; and

FIG. 9 is a block diagram illustrating certain components of the electronic device of FIG. 1.

The drawing figures do not limit the present invention to the specific embodiments disclosed and described herein. The drawings are not necessarily to scale, emphasis instead being placed upon clearly illustrating the principles of the technology.

### DETAILED DESCRIPTION

The following detailed description of various embodiments of the present technology references the accompanying drawings which illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. The following detailed description is, therefore, not to be taken in a limiting sense. The scope of the present technology is defined only by the appended claims, along with the full scope of equivalents to which such claims are entitled.

Embodiments of the present technology solve this problem by providing an improved display module for use in a touchscreen display of an electronic device. The display module includes a display screen, support structure for the display screen, and one or more LEDs or other light sources for backlighting one or more touch-sensitive fixed icons on a touch panel positioned over the display screen. The light sources are positioned or otherwise integrated between the display screen and the support structure for the display screen and are therefore integrated into the display module. Because the light sources are integrated into the display module rather than being positioned on top of the display module or mounted to the circuit board to which the display module is connected, the light sources take up otherwise unused space on the display module. This reduces the overall size and/or thickness of the electronic device and/or permits use of a larger display screen without increasing the overall size of the electronic device. Such a configuration also permits the touch-sensitive fixed icons on the touch panel to overlap a portion of the display module and still be backlit. In one embodiment described in more detail below, the light sources are mounted to a flexible printed circuit (FPC) that is positioned over a portion of an inactive border area of the display screen. The flexible printed circuit is then sandwiched between the display screen and a front bezel of the support structure for the display screen.

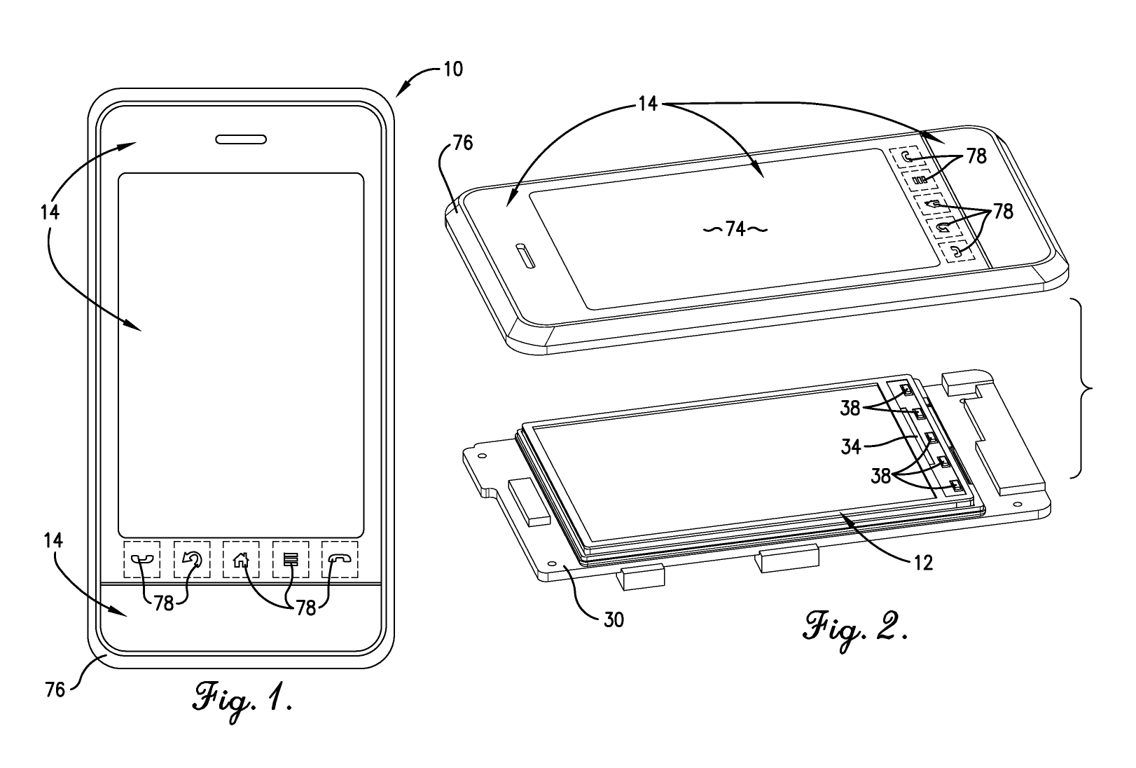

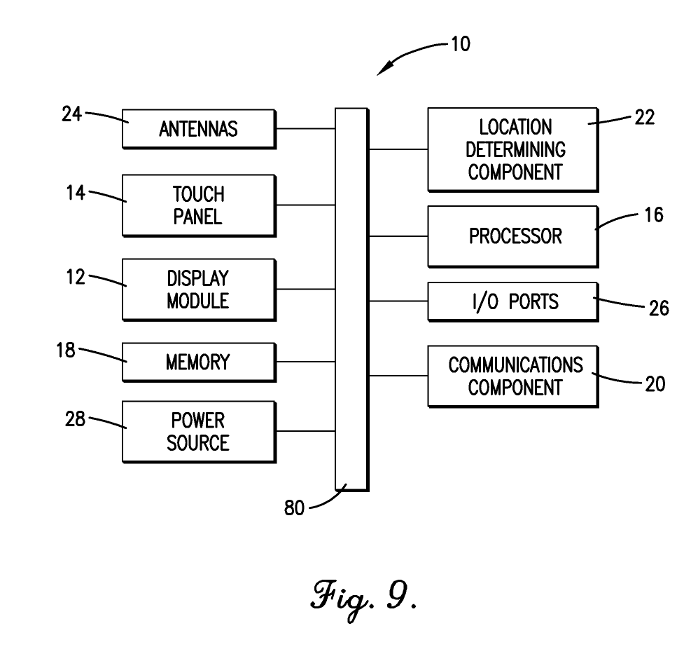

Exemplary embodiments of the present technology will now be described in more detail with reference to the drawing figures. Turning initially to FIGS. 1 and 2, an exemplary electronic device 10 in which a display module 12 and touch panel 14 constructed in accordance with embodiments of the invention may be incorporated is illustrated. The electronic device 10 may be a portable navigation device; a mobile phone; a portable media player; a mobile internet device; a laptop computer; a kiosk; a point of sale or ordering station for a restaurant, gas station, or other establishment; or any other device with a display. The display module 12 and touch panel 14 together form a touchscreen display that serves as a user interface for the electronic device 10. As best illustrated in FIG. 9, the electronic device 10 may also comprise a processor 16 and/or other electronic circuitry for executing logical and mathematical operations for the device, one or more memory elements 18, a communications component 20, a location determining component 22, one or more antennas 24, one or more input/output (I/O) ports 26, a battery or other power source 28, and a main circuit board 30 (FIG. 2) for supporting the electronic circuitry and other components of the device.

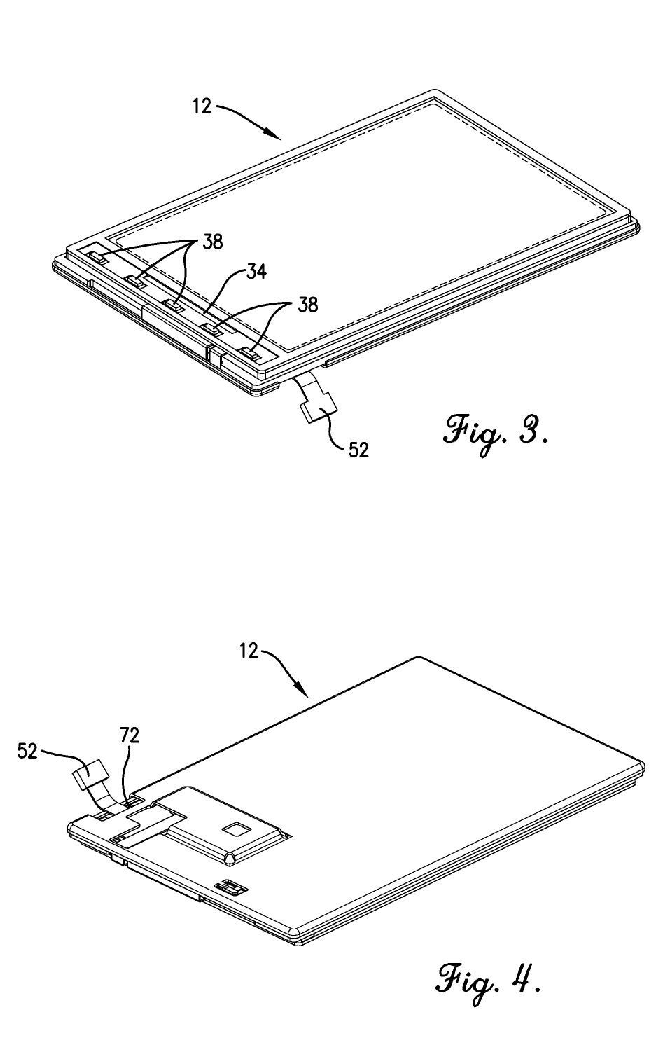

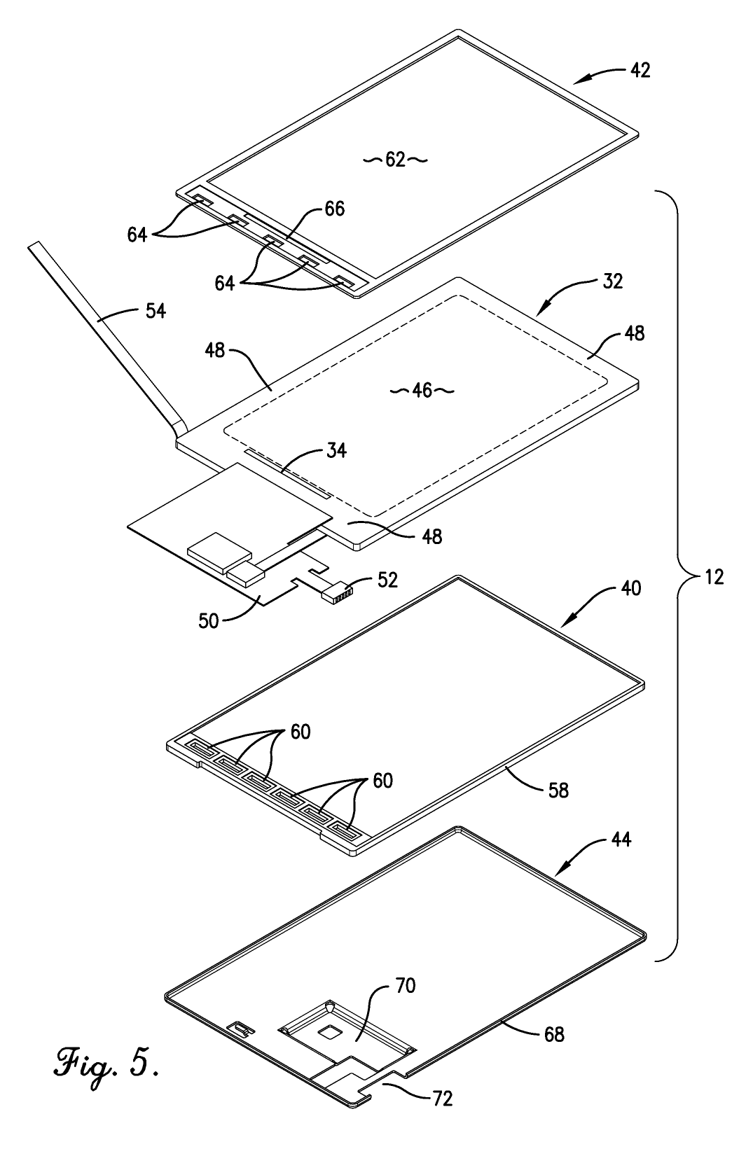

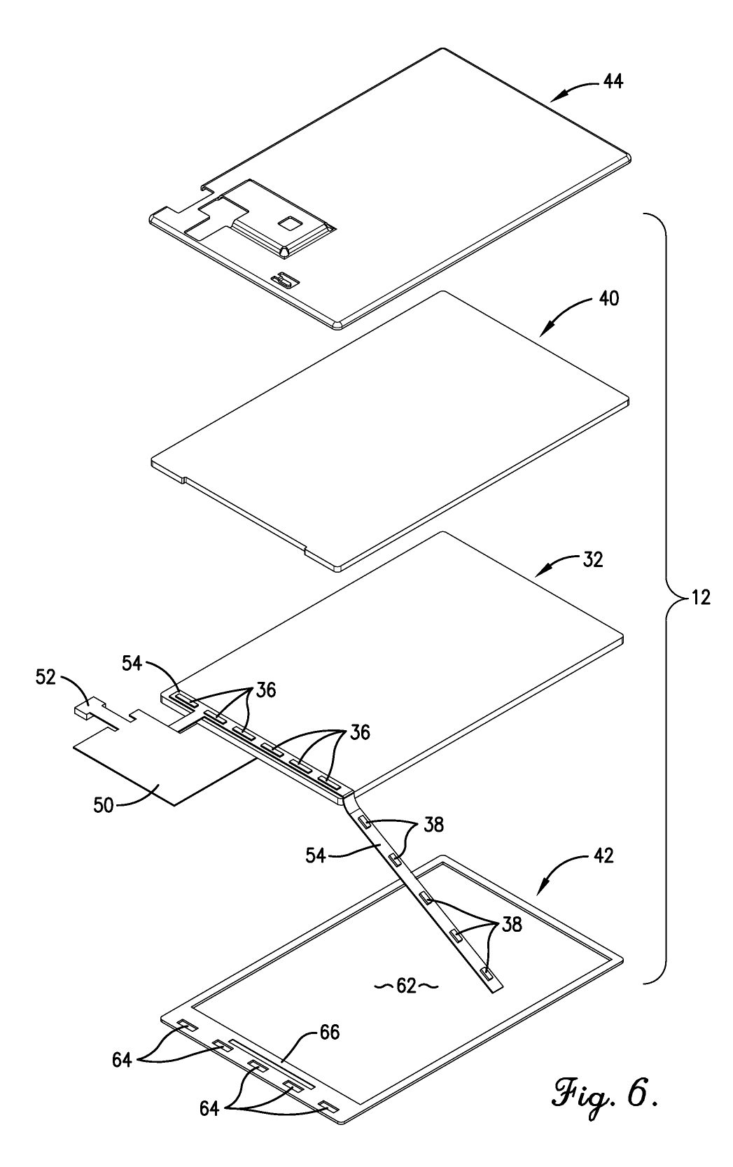

Referring now to FIGS. 3-8, and particularly FIGS. 5 and 6, an embodiment of the display module 12 is shown in more detail and may comprise a display screen 32, a display driver integrated circuit (IC) 34 or other component for driving the display screen, a plurality of light sources 36 for backlighting the entire display screen 32, a plurality of light sources 38 for backlighting touch-sensitive fixed icons 78 on the touch panel 14, a frame 40 in which the display screen 32 is seated, and a front bezel 42 and rear bezel 44 that together form a support structure for the display screen. Thus, the display module 12 includes the display screen 32 and various components that are not directly associated with, or responsible for, image generation.

In more detail, the display screen 32 is operable to display visual graphics, images, text, etc. in response to external or internal processes and commands of the electronic device's processor 16. The display screen 32 may comprise conventional black and white, monochrome, or color display elements including cathode ray tube (CRT), thin film transistor liquid crystal display (TFT-LCD), and/or light emitting diode (LED) display devices. In one embodiment, the display screen is a 3.2″ LCD with 320×480 pixel resolution.

As depicted in FIG. 5, the display screen 32 has an active display area 46 in which graphics images, text, etc. may be displayed and an inactive border area 48 on which graphics, images, text, etc. cannot be displayed. The boundary between the active display area 46 and the inactive border area 48 may vary and is generally depicted by the dashed lines on the display screen in FIGS. 3 and 5. As used herein, the term “inactive border area” or “border” means the part of the display screen 32 extending outwardly from the edge of the active display area 46 to the outside edge of the entire display module 12.

In embodiments where the display screen 32 utilizes LCD technology, the active display area 46 includes various LCD layers operable to generate a visible image (e.g., a polarizing filter film, a glass substrate, a twisted nematic liquid crystal, a second glass substrate, a second polarize filter film, a reflective surface, combinations thereof, and the like) while the inactive border area 48 includes or supports secondary components such as electrical traces, the display driver IC 34, and/or the like, that provide supporting functionality to the active display area 46.

The display driver IC 34 may be any integrated circuit or other logic device capable of storing code or other instructions for driving the display screen 32 in response to instructions from the processor 16 or other electronic circuitry of the electronic device 10. In one embodiment, the display driver IC 34 is glued or otherwise adhered to a portion of the inactive display area 48 of the display screen, but it may be positioned elsewhere without departing from the scope of the appended claims.

In one embodiment, the display driver IC 34 may be electrically connected to the processor 16 and/or other components of the electronic device 10 via a flexible printed circuit 50. The flexible printed circuit 50 may include circuitry for the display driver 34 and an electrical connector 52 that plugs into components on the main circuit board 30. The specific construction and configuration of the flexible printed circuit 50 is not germane to the technology of the present application and is therefore not described in detail herein.

The light sources 36 are best illustrated in FIG. 6 and are provided for backlighting the entire display screen 32. The light sources 36 may use any type of lighting technology such as light emitting diodes (LEDs) or incandescent lamps. Any number of light sources may be provided, and in one embodiment of the electronic device 10, six light sources are provided. The light sources 36 may be front-firing or side-firing type lights used with or without a light guide and/or a diffuser. In one embodiment, the light sources 36 are low-profile side-firing LEDs that are mounted to a thin flexible printed circuit 54 positioned on the rear face of the display screen 32. The flexible printed circuit 54 is preferably soldered or otherwise physically and electrically connected to the flexible printed circuit 50 so that the display driver IC 34 and the light sources 36 may be connected to the processor 16 or other electronic circuitry of the electronic device 10 via the same connector 52.

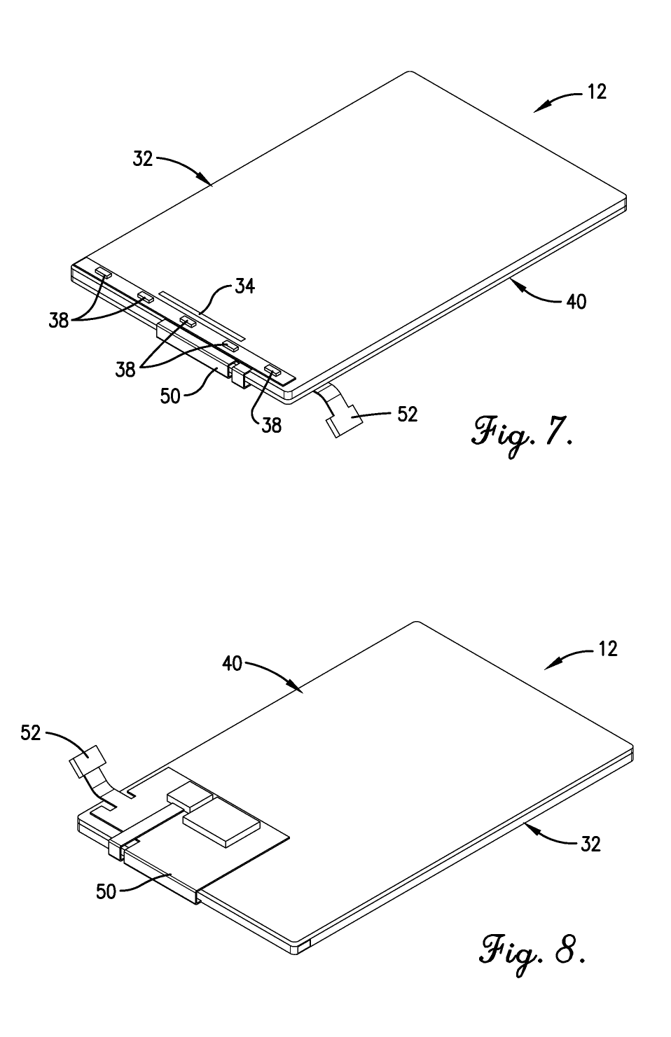

The light sources 38 are best illustrated in FIGS. 2, 3, and 7 and are provided for backlighting touch-sensitive fixed icons 78 on the touch panel 14 as described in more detail below. The light sources 38 are integrated into the display module 12 rather than being simply placed on top the display module 12 or mounted directly on the circuit board 32. The light sources 38 may be integrated into the display module 12 in any manner. In one embodiment, the light sources 38 are positioned between the display screen 32 and the front bezel 42. In the same or other embodiments, the light sources 38 may be connected to an extension of the flexible printed circuit 54 that supports the light sources 36. As best illustrated in FIGS. 5 and 7, the flexible printed circuit 54 wraps around the front of the display screen 32 and lays over a portion of the inactive display area 48 of the display screen. The flexible printed circuit 54 and the light sources 38 are then held in place by the front bezel 42 as described in more detail below.

The light sources 38 may use any type of lighting technology such as light emitting diodes (LEDs) or incandescent lamps. The light sources 38 can be front-firing or side-firing type, used with or without a light guide and/or diffuser. In one embodiment, the lights are low profile, upward-lighting type LEDs such as the CL-2825 series LEDs manufactured by Citizen Electronics Co., Ltd. The light sources 38 may be mounted within the inactive border 42 of the display module 12 below or otherwise near the display driver IC 34. However, in some configurations, the light sources 38 may be mounted anywhere within the inactive border 42.

Any number of light sources 38 may be integrated in the display module 12 for backlighting any number of touch-sensitive fixed icons on the touch panel 14. In one embodiment, the display module 12 may include a single light source, in another embodiment the display module may include three light sources, and in still another embodiment, the display module may include five light sources.

The frame 40 supports the display screen 32 and provides a reflective surface for the light sources 36. The frame 40 may include a raised outer edge 58 for securely holding the display screen and in some embodiments may include a plurality of light guides 60 and diffusers aligned with or adjacent the light sources 36 to guide and diffuse the light from the light sources 36. The frame 40 may also include a number of optical films to assist with such light diffusion. In one embodiment, the frame is made of plastic and is colored white or some other highly reflective color.

The front bezel 42 and rear bezel 44 surround and support the display screen 32 and other components of the display module and together form a support structure for the display module 12. In various embodiments, the front bezel 42 may at least partially overlay a front face portion of the display screen 32 and the rear bezel 44 may overlay the rear face of the frame 40 to provide desired support. The front and rear bezel may be formed of steel, aluminum, lightweight metals, or any other suitable material.

As shown in FIGS. 5 and 6, the front bezel 42 includes a large central opening 62 that permits unobstructed viewing of the active display area 46 of the display screen 32. The front bezel 42 may also include a number of cutouts 64 for the light sources 38 and a cutout 66 for the display driver IC 34. These cutouts may also be combined into a single cutout. The cutouts for the light sources 38 enable light generated by the sources 38 to pass through the bezel and towards the touch panel 14. The rear bezel 44 may include a raised edge 68 for receiving and positioning the front bezel 42, a protrusion 70 for accommodating the flexible printed circuit 50, and an opening 72 for permitting passage of the connector 52.

The touch panel 14 is positioned over the display module 12 and is operable for sensing touches on areas overlying the display screen 32. The touch panel 14 may be a capacitive type touch panel, a resistive type touch panel, a surface acoustic wave type touch panel, an infrared type touch panel, or a strain gauge type touch panel.

The touch panel 14 may be formed of glass, clear plastic, or any other transparent material and has a transparent area 74 that substantially overlies the active display area 46 on the display screen 32 so that graphics, images, text, etc. displayed on the display screen can be seen through the touch panel. The transparent panel 74 may be mounted within a frame 76 or housing that fits over the display module 12 and that attaches to a back panel or cover of the electronic device.

The touch panel 14 also includes one or more touch-sensitive fixed icons 78 that are backlit by the light sources 38 of the display module and that may be touched to execute certain popular functions of the electronic device. The touch-sensitive fixed icons 78 may be etched in or printed on the touch panel 14 and aligned with and therefore illuminated by the light sources 38 of the display module. However, the touch-sensitive fixed icons 78 may comprise any portion of the touch panel 14. The touch-sensitive fixed icons may enable any functions of the electronic device 10 such as “Home,” “Menu,” “Back,” “Send,” or “End.” In various embodiments, the touch panel 14 is larger than the active display area 46 of the display screen 32.

The above-described construction and configuration of the display module 12 provides numerous advantages. For example, because the light sources 38 are integrated into the display module 12 rather than being positioned on top of the display module or mounted to the circuit board 30 to which the display module is connected, the light sources 38 take up otherwise unused space on the display module. This reduces the overall size and/or thickness of the electronic device 10 and/or permits use of a larger display screen 32 without increasing the overall size of the electronic device 10. Such a configuration also permits the touch-sensitive fixed icons 78 on the touch panel 14 to overlap a portion of the display module 12 and still be backlit.

The other components of the electronic device 10 may include conventional electronic components to provide desired functionality. The processor 16 may be any electronic device or component capable of executing logical and mathematical operations on data. The processor 16 may be a single electronic component or it may be a combination of components that provide the requisite functionality. The processor 16 may comprise a microprocessor, a microcontroller, programmable logic controller (PLC), field-programmable gate array (FPGA), application specific integrated circuit (ASIC), or any other component or components that are operable to perform, or assist in the performance of, the required operations. The processor may be coupled with other components of the electronic device through wired or wireless connections, such as a data bus 80, to enable information to be exchanged between the various components.

The memory elements 18 may be any electronic memory that can be accessed by the processor 16 and operable for storing instructions or data. The memory elements 18 may be a single component or may be a combination of components that provide the requisite functionality. The memory elements 18 may include various types of volatile or non-volatile memory such as flash memory, optical discs, magnetic storage devices, SRAM, DRAM, or other memory devices capable of storing data and instructions. The memory elements 18 may communicate directly with the processor 16, or they may communicate with the processor over the bus 80 or other mechanism that facilitates direct or indirect communication between the devices. The memory elements may optionally be structured with a file system to provide organized access to data existing thereon.

The communications component 20 enables the device 10 to communicate with other electronic devices through a communication network, such as a cellular phone network, the Internet, a local area network, a wide area network, and ad hoc or peer to peer network, or a direct connection such as a USB, Firewire, or Bluetooth™ connection, etc. The communications component 20 may communicate utilizing wireless data transfer methods such as WiFi (802.11), Wi-Max, Bluetooth™, ANT®, ultra-wideband, infrared, cellular telephony, radio frequency, etc. The communications component 20 may make and receive any communications including incoming and outgoing phone calls, text messages, instant message, voicemail messages, e-mail message, missed phone calls, and any other known communications. In one embodiment, the communications component 20 is a cellular transceiver for transmitting and receiving communications over a cellular phone network such as those operated by Sprint®, AT&T®, Verizon®, and other companies. The cellular phone network may operate with GSM (Global System for Mobile communications), CDMA (Code Division Multiple Access), or any other known standards.

The location determining component 22 determines locations of the electronic device 10 as it is carried or otherwise moved from place to place. The location determining component 22 may be a satellite navigation receiver that works with a global navigation satellite system (GNSS) such as the global positioning system (GPS) primarily used in the United States, the GLONASS system primarily used in the Soviet union, or the Galileo system primarily used in Europe.

The antennas 24 may include an antenna for the location determining component 22 to assist in receiving satellite signals and an antenna for the communications component 20 to assist in receiving and transmitting wireless communications. The antennas may be patch antennas, linear antennas, or any other type of antennas.

The I/O ports 26 permit data and other information to be transferred to and from the electronic device 10. The I/O ports 26 may include a Secure Digital (SD) card slot, Mini SD Card slot, Micro SD Card slot or the like for receiving removable SD cards, Mini SD Cards, Micro SD Cards, or the like, and a USB port for coupling with a USB cable connected to another computing device such as a personal computer. Navigational software, cartographic maps and other data and information may be loaded in the electronic device 10 via the I/O ports 26.

The power source 28 provides electrical power to the other components of the electronic device 10 and may comprise conventional power supply elements, such as batteries, battery packs, etc. The power source 28 may also comprise power conduits, connectors, and receptacles operable to receive batteries, battery connectors, or power cables,. For example, the power source 28 may include both a battery to enable portable operation and a power input for receiving power from an external source such as an automobile or home computer/wall outlet.

The circuit board 30 may be any conventional circuit board or other type of electronic substrate operable for supporting and electrically interconnecting one or more components of the electronic device 10.

The components of the electronic device may be supported in a handheld or otherwise portable housing to facilitate easy transport of the device. The housing may comprise the frame 76 of the touch panel 14 along with a back panel or plate (not shown) that connects with the frame 76. The housing may be constructed from a suitable lightweight and impact-resistant material such as, for example, plastic, nylon, aluminum, or any combination thereof and may include one or more appropriate gaskets or seals to make it substantially waterproof or resistant. The housing may take any suitable shape for size, and the particular size, weight and configuration of the housing may be changed without departing from the scope of the present invention.

The components of the electronic device and described herein need not be physically connected to one another since wireless communication among the various depicted components is permissible and intended to fall within the scope of the present invention.

Although various embodiments of the invention have been described herein with reference to attached drawing figures, it is noted that equivalents may be employed and substitutions made herein without departing from the scope of the invention as recited in the claims.

What is claimed is:

1. A display module for use in a touchscreen display, the display module comprising:
a display screen having an inactive border;
a support structure for the display screen; and
a light source supported between the inactive border of the display screen and the support structure for backlighting a component placed over the display module.

2. The display module as set forth in claim 1, wherein the support structure comprises a front bezel that partially overlays a front face of the display screen and that sandwiches the light source on the inactive border of the display screen.

3. The display module as set forth in claim 1, wherein the light source is mounted to a flexible printed circuit that is sandwiched between the display screen and the support structure.

4. The display module as set forth in claim 3, further comprising a plurality of backlights positioned on a rear face of the display screen for backlighting the display screen.

5. The display module as set forth in claim 4, wherein the backlights for the display screen and the light source are mounted to a common flexible printed circuit.

6. The display module as set forth in claim 2, wherein the front bezel includes a cutout for the light source.

7. The display module as set forth in claim 1, wherein the display module further comprises a display driver for driving the display screen.

8. The display module as set forth in claim 1, wherein the component backlighted by the light source is a touch-sensitive fixed icon integrated into a touch panel positioned over the display module.

9. The display module as set forth in claim 1, further comprising a plurality of light sources positioned between the display screen and the support structure for backlighting a plurality of touch-sensitive fixed icons integrated into a touch panel positioned over the display module.

10. The display module as set forth in claim 9, wherein the touch-sensitive fixed icons enable functions of Home, Menu, Back, Send, or End in an electronic device in which the display module is mounted.

11. The display module as set forth in claim 1, wherein the light source is an upward-lighting type LED.

12. A touchscreen display for an electronic device, the touchscreen display comprising:
a display module comprising—
a display screen having an inactive border,
a support structure for the display screen, and
a light source supported between the inactive border of the display screen and the support structure; and
a touch panel positioned over the display module for sensing touches thereon, the touch panel having an integral touch-sensitive fixed icon aligned with and illuminated by the light source of the display module.

13. The touchscreen display as set forth in claim 12, wherein the support structure comprises a front bezel that partially overlays a front face of the display screen and that sandwiches the light source on the inactive border of the display screen.

14. The touchscreen display as set forth in claim 12, wherein the light source is mounted to a flexible printed circuit that is positioned between the display screen and the support structure.

15. The touchscreen display as set forth in claim 14, further comprising a plurality of backlights positioned on a rear face of the display screen for backlighting the display screen.

16. The touchscreen display as set forth in claim 15, wherein the backlights for the display screen and the light source are mounted to a common flexible printed circuit.

17. The touchscreen display as set forth in claim 12, wherein the display module further comprises a display driver for driving the display screen.

18. The touchscreen display as set forth in claim 12, wherein the touch panel is a capacitive type touch panel.

19. The touchscreen display as set forth in claim 12, wherein the touch panel is a resistive, surface acoustic wave, infrared, or strain gauge type touch panel.

20. An electronic device comprising:
a circuit board;
electronic circuitry mounted on the circuit board for performing logical operations;
a display module electrically connected to the circuit board for displaying information related to the logical operations, the display module comprising
a display screen having an inactive border,
a support structure for the display screen, and
a light source supported between the inactive border of the display screen and the support structure; and
a touch panel positioned over the display module for sensing touches thereon, the touch panel having an integral touch-sensitive fixed icon aligned with and backlit by the light source of the display module.
